(19) United States
(12) Patent Application Publication
(10) Pub. No.: US 2006/0170746 A1
(43) Pub. Date: Aug. 3, 2006

(54) Inkjet ink set

(76) Inventor: Christian Jackson, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/327,522

(22) Filed: Jan. 6, 2006

Related U.S. Application Data
(60) Provisional application No. 60/642,742, filed on Jan. 10, 2005.

(51) Int. Cl. G01D 11/00

(52) U.S. Cl. 347/100

(57) ABSTRACT

This invention pertains to an ink set for inkjet printing, in particular to an ink set comprising a first ink containing a self-dispersing pigment colorant with sulfonate dispersibility imparting groups, and a fixer ink for the first ink that can be printed under the first ink to increase its coloristic properties.

### CROSS-REFERENCE TO RELATED APPLICATIONS

This application claims priority under 35 U.S.C. §119 from U.S. Provisional Application Ser. No. 60/642,742 (filed Jan. 10, 2005), the disclosure of which is incorporated by reference herein for all purposes as if fully set forth.

### BACKGROUND OF THE INVENTION

This invention pertains to an ink set for inkjet printing, in particular to an ink set comprising a first ink containing a self-dispersing pigment colorant with sulfonate dispersibility imparting groups and a second, colorless ink that can be printed under the first ink to increase its coloristic properties.

Inkjet printing is a non-impact printing process in which droplets of ink are deposited on print media, such as paper, to form the desired image. The droplets are ejected from a printhead in response to electrical signals generated by a microprocessor.

Both dyes and pigments have been used as colorants for inkjet inks. Aqueous-based inks comprising pigments tend to be advantageous, compared to dyes, in water-fastness and light-fastness of the printed images.

Pigments suitable for aqueous inkjet inks are in general well-known in the art. Traditionally, pigments have been stabilized by dispersing agents, such as polymeric dispersants or surfactants, to produce a stable dispersion of the pigment in the vehicle. More recently though, so-called “self-dispersible” or “self-dispersing” pigments (hereafter “SDP”) have been developed. SDPs are pigments whose surface has been chemically modified to render them dispersible in water without dispersants. Most frequently, the surface modification involves addition of either carboxylate (carboxylated SDP) or sulfonate (sulfonated SDP) dispersibilty-imparting groups. SDPs are often advantageous over traditional dispersant stabilized pigments from the standpoint of greater stability and lower viscosity at the same pigment loading, which can provide greater formulation latitude in final ink.

Preparation of SDPs are described, for example, in U.S. Pat. No. 5,571,331, U.S. Pat. No. 5,968,243, U.S. Pat. No. 5,928,419, U.S. Pat. No. 6,323,257, U.S. Pat. No. 6,123,759, U.S. Pat. No. 6,468,342, U.S. Pat. No. 6,503,311, U.S. Pat. No. 6,506,245, U.S. Pat. No. 6,599,356, WO01/94476 and EP-A-1146090, the disclosures of which are incorporated by reference herein for all purposes as if fully set forth.

To increase the optical density and chroma of a pigment ink, a fixing fluid can sometimes be applied prior to the ink to “crash” the dispersed pigment near the media surface and prevent penetration. See, for example, US20040035319 (the disclosure of which is incorporated by reference herein for all purposes as if fully set forth). This has been shown to work well for carboxylated SDP but not for sulfonated SDP.

U.S. Pat. No. 6,450,632 discloses the combination of ink and underprinting fixing fluid wherein the ink contains a sulfonated macromolecular chromophore (sulfonated SDP) having a zeta potential of 100-900 millivolts, and the fluid contains a cationic component. At best, only small increases in OD and chroma are reported and in many of the examples underprinting with a fixer decreases OD or chroma or both. The aforementioned disclosure is incorporated by reference herein for all purposes as if fully set forth.

It is an objective of this invention to provide increased optical density and chroma in inks comprising a sulfonated SDP.

### SUMMARY OF THE INVENTION

In accord with an objective of this invention, there is provided an inkjet ink set comprising:

(a) a first ink comprising a first colorant, a first carboxyl-groups containing polymer additive and a first aqueous vehicle; and

(b) a fixer ink for the first ink, the fixer ink comprising a fixing agent and a second aqueous vehicle;

wherein, the first colorant is a self-dispersing pigment with sulfonate dispersibility imparting groups.

In one preferred embodiment, the first ink is a black ink with the first colorant being a self-dispersing carbon black pigment.

In another preferred embodiment, the ink set further comprises a second and third ink, said second ink comprising a second colorant, a second carboxyl-groups containing polymer additive and a third aqueous vehicle; and said third ink comprising a third colorant, a third carboxyl-groups containing polymer additive and a fourth aqueous vehicle; wherein the second and third colorants are both self-dispersing pigments with sulfonate dispersibilty imparting groups, and the color of each of the first, second and third inks is different. Particularly preferred for this embodiment is when the first, second and third inks are, respectively, cyan, magenta and yellow in color.

In another preferred embodiment, in addition to the first, second and third colored inks, the ink set further comprises a fourth ink comprising a fourth colorant and a fifth aqueous vehicle, wherein the fourth colorant is a self-dispersing carbon black pigment with carboxylate dispersibility imparting groups.

In yet another preferred embodiment, the carboxyl-groups containing polymer additive in one or more of the colored inks comprises a combination of both a random carboxyl-groups containing polymer and a structured carboxyl-groups containing polymer; and/or the fixing agent is selected from the group consisting of a multivalent metal cation, a water-soluble cationic polymer and mixtures thereof.

The invention further pertains to an inkjet printer equipped with an inkjet ink set as set forth above and as described in further detail below.

The present invention also relates to a method for ink jet printing onto a substrate, comprising the steps of:

(a) providing an ink jet printer that is responsive to digital data signals;

(b) loading the printer with a substrate to be printed;

(c) loading the printer with an inkjet ink set as set forth above and as described in further detail below; and

(d) printing onto the substrate using the inkjet ink set in response to the digital data signals.

Finally, the present invention relates to an article printed with the above-mentioned ink set, using the above-mentioned printer, and/or using the above-mentioned printing method.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise.

### DETAILED DESCRIPTION OF THE PREFERRED EMBODIMENTS

Colorant

The colorant in the first ink(s) of present invention is a pigment. By definition, pigments do not form (to a significant degree) a solution in the aqueous vehicle and must be dispersed.

The pigment colorants in the first ink(s) of the present invention are more specifically self-dispersing pigments. SDPs are surface modified with dispersibility imparting groups to allow stable dispersion without separate dispersant. For dispersion in aqueous vehicle, the surface modification involves addition of hydrophilic groups and most typically ionizable hydrophilic groups.

The SDP colorant can be further defined by its ionic character. Anionic SDP yields, in aqueous medium, particles with anionic surface charge. Conversely, cationic SDP yields, in aqueous medium, particles with cationic surface charge. Particle surface charge can be imparted, for example, by attaching groups with anionic or cationic moieties to the particle surface.

Anionic moieties attached to the anionic SDP surface are primarily species of type (I) “carboxylate” or (II) “sulfonate” as shown:
—CO₂Z (I) —SO₃Z (II)
wherein Z is selected from the group consisting of conjugate acids of organic bases; alkali metal ions; “onium” ions such as ammonium, phosphonium and sulfonium ions; and substituted “onium” ions such as tetraalkylammonium, tetraalkyl phosphonium and trialkyl sulfonium ions; or any other suitable cationic counterion.

Sulfonated anionic (type II) SDPs include those described, for example, in previously incorporated references U.S. Pat. No. 5,571,331, U.S. Pat. No. 5,968,243, U.S. Pat. No. 5,928,419, U.S. Pat. 6,323,257 and EP-A-1146090. Commercial sources include Cabot Corp. (Billerica, Mass.) and Toyo Ink USA LLC (Addison, Ill.).

It is desirable to use small colorant particles for maximum color strength and good jetting. The particle size may generally be in the range of from about 0.005 micron to about 15 microns, is typically in the range of from about 0.005 to about 1 micron, is preferably from about 0.005 to about 0.5 micron, and is more preferably in the range of from about 0.01 to about 0.3 micron.

The levels of SDPs employed in the instant inks are those levels that are typically needed to impart the desired OD to the printed image. Typically, SDP levels are in the range of about 0.01 to about 10% by weight of the ink.

The SDPs may be black, such as those based on carbon black, or may be colored pigments such as those based on PB 15:3 and 15:4 cyan, PR 122 and 123 magenta, and PY 128 and 74 yellow.

Vehicle

“Aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

The aqueous vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

Carboxyl Groups-Containing Polymer

A carboxyl groups-containing polymer is a polymer that is water soluble or dispersible and has carboxylic acid groups (in the acid form or neutralized as “carboxylate”). The polymer may contain other ionic or nonionic hydrophilic groups such as ether, hydroxyl and amide groups.

Suitable polymers can be soluble or dispersed polymer(s). Soluble polymers may include linear homopolymers, copolymers or block polymers, they also can be structured polymers including graft or branched polymers, stars, dendrimers, etc. The dispersed polymers may include, for example, latexes and hydrosols. The polymers may be made by any known process including but not limited to free radical, group transfer, ionic, RAFT, condensation and other types of polymerization. They may be made by a solution, emulsion, or suspension polymerization process.

The soluble/dispersible polymer may include copolymers of acrylates, methacrylates, styrene, substituted styrene, α-methylstyrene, substituted α-methyl styrenes, vinyl naphthalenes, vinyl pyrollidones, maleic anhydride, vinyl ethers, vinyl alcohols, vinyl alkyls, vinyl esters, vinyl ester/ethylene copolymers, acrylamides, and methacrylamides.

The polymer may also be a polyester or polyurethane.

In a preferred embodiment, the carboxyl-groups containing polymers are linear and soluble in the vehicle. Preferably the number average molecular weight (Mₙ) is in the range of 1,000 to 20,000, more preferably 1,000 to 10,000 and most preferably 2,000 to 6,000.

The acid content of the polymer should be sufficient to provide the necessary solubility/dispersibility, but no so high that the polymer becomes insensitive to fixation. In one preferred embodiment, the acid content is between about 0.65 and about 2.9 milliequivalents per gram of polymer.

In a particularly preferred embodiment, the soluble binder polymer is comprised substantially of monomers of (meth)acrylic acid and/or derivatives thereof, and the preferred Mₙ is between about 4000 to about 6000.

When present, soluble polymer is advantageously used at levels, based on the final weight of ink, of at least 0.3% and preferably at least about 0.6%. Upper limits are dictated by ink viscosity or other physical limitations. In a preferred embodiment, no more than about 3% soluble polymer is present in the ink, and even more preferably no more than about 2%, based on the total weight of the ink.

Fixing Fluid

A fixing (fixer) fluid is an “ink” with fixing agent and vehicle, but preferably substantially no colorant. And, because the fixing fluid is jetted it is considered part of the “ink set”. However, for the sake of convenience and clarity, the term “ink” will generally be used herein to indicate an ink with colorant but no fixing agent. Preferably, the fixing fluid contains substantially no colorant, and/or is substantially clear. Also, preferably, the fixing fluid can be printed on the substrate and leave no visible marking.

The fixing fluid contains an “effective amount” of fixing agent which, as used above and otherwise herein, is an amount required to achieve an improvement in OD and/or rub-fastness as compared to an ink set without the presence of the fixer. The fixing agent is believed to interact with the carboxyl moieties on the polymer, causing the polymer to aggregate and thereby inhibit penetration of the pigment into the media.

Fixing agents will typically operate by electrostatic interaction with the (anionic) carboxyl-groups containing polymer. Thus, the fixing agent is generally a cationic species.

A cationic fixing agent can be, for example, a cationic polymer. The cationic polymeric fixing agent can be a water-soluble polymer, a hydrosol or dispersed polymer, or an emulsion polymer dispersed in the liquid composition vehicle. Examples of preferred water-soluble cationic polymers are protonated forms of polyamines including polyethyleneimine, polyvinylpyridine, polyvinylamine, polyallylamine and combinations thereof. In preferred embodiments, the cationic polymer is selected from the group polyethyleneimines, water-soluble cationic dendrimers, water-dispersed alkoxylated forms of polyethylenimines, water-soluble dispersed alkoxylated forms of cationic dendrimers, and poly diallyidimethyl ammonium chlorides. In a particularly preferred embodiment, the soluble cationic polymer is a polyethyleneimine. The preferred molecular weight, Mₙ, of soluble polymer fixing agents is between about 1,000 and 10,000 g/mol.

The cationic polymer may also be a copolymer of different cationic monomers or a copolymer of cationic and nonionic monomers. The copolymer can be random or structured, linear, grafted (comb) or branched.

A cationic fixing agent can also be, for example, a soluble salt of a multivalent metal. “Multivalent” indicates an oxidation state of two or more and, for an element “Z”, are typically described as Z²⁺, Z³⁺, Z⁴⁺ and so forth. The multivalent cations are soluble in the aqueous ink vehicle and preferably exist in a substantially ionized state.

Multivalent cations include the multivalent cationic forms of the following elements: Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb. Preferred those of the elements Ca, Mg, Zn, Cu and Al.

The cationic fixing agent can advantageously be a combination of one or more types of cationic polymer(s) and one or more types of multivalent metal cation(s).

The fixing fluid will typically be deposited on the substrate before the ink (underprinted), and preferably substantially only in areas subsequently printed with colored ink. The area covered by the fixer (area fill) need not, however, entirely fill the area printed with colored ink. Also, the ink need not fall (entirely) on top of the fixer. To minimize the liquid load on the substrate, the fixer ink(s) are preferably formulated to be effective at volumes equal to or less than the volume of colored ink being fixed. The need for only a small amount of fixer area fill is highly advantageous as this decreases the liquid load the substrate must handle. High liquid load can result in cockle or curl of paper substrate.

Other Ingredients

Other ingredients may be formulated into the inkjet ink, to the extent that such other ingredients do not interfere with the stability and jetablity of the ink, which may be readily determined by routine experimentation. Such other ingredients are in a general sense well known in the art.

Biocides may be used to inhibit growth of microorganisms.

If desired, polymeric binder other than the prescribed carboxyl-groups containing polymer can be included in the colored ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element, or ejection conditions for a thermal head, for either a drop-on-demand device or a continuous device, and the shape and size of the nozzle. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity (at 25° C.) of the inventive inks and fixer can be less than about 7 cps, is preferably less than about 5 cps, and most advantageously is less than about 3.5 cps. Thermal inkjet actuators rely on instantaneous heating/bubble formation to eject ink drops and this mechanism of drop formation generally requires inks of lower viscosity.

Ink Sets

The present invention pertains in one aspect to an inkjet ink set comprising a first ink and a second ink. The first ink comprises a first colorant, a first carboxyl-groups containing polymer additive and a first aqueous vehicle. The first colorant is a self-dispersing pigment with dispersibility imparting groups that are primarily sulfonate groups. The second ink is a fixing ink comprising a fixing agent and a second aqueous vehicle. The second ink, when applied under the first ink, “fixes” the first ink and thereby increases optical density of the first colorant. In a preferred embodiment, the first colorant is a self-dispersing cyan, magenta or yellow pigment with dispersibility imparting groups that are primarily sulfonate groups. The ink set can optionally comprise additional inks which additional inks can contain SDP colorant or other colorants such as dye and dispersant stabilized pigments.

In another aspect, an ink set according to the present invention comprises a first, second, third and fourth ink. The first and second inks are as defined immediately above. The third ink comprises a second colorant, a second carboxyl-groups containing polymer additive and a third aqueous vehicle. The fourth ink comprises a third colorant, a third carboxyl-groups containing polymer additive and a fourth aqueous vehicle. The first, second and third colorant are a self-dispersing pigments with dispersibility imparting groups that are primarily sulfonate groups. The first colorant is preferably cyan in color, the second colorant is preferably magenta in color and the third colorant is preferably yellow in color.

With regard to colors, the color cyan is defined as a hue angle of between 180 and 250; the color magenta is defined as a hue angle of between 320 and 10; and the color yellow is defined as a hue angle between 70 and 120.

In addition to the first, second, third and fourth inks prescribed above, an ink set can further comprise a fifth ink. The fifth ink comprises fourth colorant and a fifth aqueous vehicle. The fourth colorant is a self-dispersing carbon black pigment with dispersibility imparting groups that are either primarily sulfonate groups or primarily carboxylate groups. If the fourth colorant comprises dispersibility imparting groups that are primarily sulfonate groups, the fifth ink further comprises a fourth carboxyl-groups containing polymer additive. If the fourth colorant comprises dispersibility imparting groups that are primarily carboxylate groups, additional polymer is not required. The carboxylated SDP can be, for example, the carboxylated SDP described in previously incorporated WO01/94476.

Substrate

The instant invention is particularly advantageous for printing on plain paper such as common electrophotographic copier paper, although the invention is not restricted to use of such media.

### EXAMPLES

In the examples below, proportions of ingredients are expressed in weight pecent of the total weight of ink, unless otherwise specified. Water was deionized prior to use. Viscosity was measured at about 25° C. according to standard Brookfield viscometry methods. Surface tension was measured with a Kruss K100 tensiometer.

Dispersion 1

Dispersion 1 was Cabojet® IJX 250, a sulfonated anionic cyan SDP from Cabot Corporation. It was supplied as a 9.9 weight percent pigment in water and was used as received.

Dispersion 2

Dispersion 2 was Cabojet® IJX 260, a sulfonated anionic magenta SDP from Cabot Corporation. It was supplied as a 9.7 weight percent pigment in water and was used as received.

Yellow Dispersion 3

Dispersion 3 was Cabojet® IJX 270, a sulfonated anionic yellow SDP from Cabot Corporation. It was supplied as a 10.2% weight percent pigment in water and was used as received.

Dispersion 4

Pigment R122 (Clariant EWD) was oxidized with ozone according to the process described in previously incorporated WO01/94476. After recovery, a 14.6 weight percent dispersion of self-dispersing PR122 in water was obtained with a viscosity of 3.0 cps (25° C.). The median particle size was 118 nm.

Dispersion 5

Dispersion 5 was Cabojet® IJX 253, a sulfonated anionic blue SDP from Cabot Corporation. It was supplied as a 9.9 weight percent pigment in water and was used as received.

Preparation of Soluble Polymer Binder 1

A block copolymer of methacrylic acid//benzyl methacrylate//ethyltriethyleneglycol methacrylate was prepared in a manner similar to “preparation 4” described in U.S. Pat. No. 5,519,085 (the disclosure of which is incorporated by reference herein for all purposes as if fully set forth), except the mole ratio of monomers was (13//15//14). Number average molecular weight was about 5,000, and weight average molecular weight was about 6,000 g/mol.

Preparation of Soluble Polymer Binder 2

A random copolymer of methacrylic acid/benzyl methacrylate/ethyltriethyleneglycol methacrylate/(13/15/4 mole ratio) was made according to conventional polymerization techniques. Number average molecular weight was about 5,000, and weight average molecular weight was about 6,000 g/mol.

Preparation of Fixer Fluids

Fixer fluids were prepared by mixing ingredients together according to the following recipe. Surfynol® 465 is a surfactant from Air Products Corporation.

| Fixer Formulation | % weight |
|---|---|
| Fixing Agent | As indicated |
| Tetraethylene glycol | 6.0% |
| 2-Pyrrolidone | 4.0% |
| 1,5-Pentanediol | 10.0% |
| Surfynol ® 465 | 0.5% |
| Water | Balance |

Using this formulation, the following fixer fluids were prepared.

| Fixing Fluid | Fixing Agent (as a % weight of final fluid) |
|---|---|
| Fixer A1 | Calcium nitrate tetrahydrate (3.5%) |
| Fixer B1 | Copper nitrate hemipentahydrate (3.45%) |
| Fixer C1 | Polyethyleneimine (3.5%) |

Fixers A1 and B1 each contain the same amount, on a molar basis, of their respective multivalent cation (0.15 mol/L). Polyethyleneimine (PEI) was Lupasol® FS from BASF. Proxel® GXL is a biocide from Avecia Corporation.
Substrate

The following papers were used as substrate in print tests: Hammermill Copy Plus (HCP), Xerox 4024 (X4024), Hewlett Packard Office paper (Hpoff), Epson Premium Glossy Photo Paper and Melinex Photo Paper (Lexjet Corp., Sarasota, Fla., USA).

Print Testing

The inks were filled into Canon 3e series cartridges and printed with a Canon i550 printer, unless otherwise specified. Print patterns were created in CorelDraw (Corel Corporation) and the software was also used to control the area fill of the fixer.

Fixer was printed over entire page at the desired area fill. The page was then re-fed to the printer equipped with colored ink and printed (100% area fill) on top of the fixer. Typically there was a period of 3 to 5 seconds between printing the fixer and printing the ink. Extending this period to 24 hours made no significant difference to the change in OD obtained.

Measurement of OD and Chroma

OD and Chroma were measured using a Greytag-Macbeth SpectroEye (Greytag-Macbeth AG, Regensdorf, Switzerland).

Measurement of Gloss

Gloss was measured with a Byk-Gardner micro-TRI-gloss meter.

Measurement of Distinctness-of-Image

Distinctness-of-image (DOI) gloss is the distinctness and sharpness of images reflected by a glossy surface. It is thus different from, though related to, specular gloss which is the fraction of light reflected specularly from a shiny surface. A smooth surface has a high DOI value and images reflected in the surface appear sharp and distinct. High DOI is generally perceived as desirable.

DOI was measured using a Model GB11-8GM Distinctness of Image Meter (Gardner Company, Pompano Beach, Fla.). The rating of DOI is evaluated in increments of 10 from 100 (best, highest DOI) to 10 (worst). This method of evaluating DOI is an industry standard and corresponds to General Motors Engineering Standard “Test for evaluating distinctness of image GM 9101P”.

### Example 1

Inks 1-3 and comparative Inks A-C were prepared according to the recipe in the following table. Ingredient amounts in this and other examples are expressed as weight percent of the total weight of ink.

The inks were printed onto plain paper with and without fixer. Results demonstrate that comparative inks A-C formulated with just pigment and ink vehicle dispersion (no polymer) show little or no increase in optical density or chroma when they are printed on top of either fixers A1 or B1. In contrast, the inventive inks 1-3 (with carboxyl-groups containing polymer) show large increases in both chroma and optical density when printed on top of the same fixers.

| | Cyan Inks | | Magenta Inks | | Yellow Inks | |
|---|---|---|---|---|---|---|
| | Ink A (comp.) | Ink 1 | Ink B (comp.) | Ink 2 | Ink C (comp.) | Ink 3 |
| Ingredients | | | | | | |
| Dispersion 1 (as % pigment) | 3.0 | 3.0 | — | — | — | — |
| Dispersion 2 (as % pigment) | — | — | 3.0 | 3.0 | — | — |
| Dispersion 3 (as % pigment) | — | — | — | — | 3.0 | 3.0 |
| Binder 2 (as % polymer) | — | 1.5 | — | 1.5 | — | 1.5 |
| 1,2-Hexanediol | 4.0 | 4.0 | 4.0 | 4.0 | 4.0 | 4.0 |
| Glycerol | 10.0 | 10.0 | 10.0 | 10.0 | 10.0 | 10.0 |
| Ethylene glycol | 5.0 | 5.0 | 5.0 | 5.0 | 5.0 | 5.0 |
| 2-Pyrrolidone | 3.0 | 3.0 | 3.0 | 3.0 | 3.0 | 3.0 |
| Surfynol ® 465 | 0.5 | 0.5 | 0.5 | 0.5 | 0.5 | 0.5 |
| Water (balance to 100%) | Bal. | Bal. | Bal. | Bal. | Bal. | Bal. |
| Properties | | | | | | |
| Conductivity (ms/cm) | 0.32 | 1.4 | 0.16 | 1.3 | 0.15 | 1.3 |
| Surface tension (dynes/cm) | 30.4 | 33.9 | 30.4 | 36.8 | 29.9 | 34.5 |
| pH | 6.1 | 8.6 | 5.6 | 8.6 | 6.5 | 8.6 |
| Viscosity (cps, 25° C.) | 2.13 | 2.98 | 2.3 | 3.14 | 2.19 | 3.21 |

Optical Density on Various Paper

| Ink | Fixer | HPoff | HCP | X4024 | (Average) |
|---|---|---|---|---|---|
| Ink A (comp.) | No Fixer | 0.96 | 0.91 | 0.89 | 0.92 |
| Ink 1 | No Fixer | 0.94 | 0.89 | 0.97 | 0.93 |
| Ink A (comp.) | Fixer A1 | 0.99 | 0.93 | 0.96 | 0.96 |
| Ink 1 | Fixer A1 | 1.00 | 0.97 | 1.15 | 1.04 |
| Ink A (comp.) | Fixer B1 | 0.96 | 0.94 | 0.89 | 0.93 |
| Ink 1 | Fixer B1 | 1.00 | 0.97 | 1.19 | 1.05 |
| Ink B (comp.) | No Fixer | 0.83 | 0.79 | 0.86 | 0.83 |
| Ink 2 | No Fixer | 0.84 | 0.78 | 0.84 | 0.82 |
| Ink B (comp.) | Fixer A1 | 0.90 | 0.88 | 0.90 | 0.89 |
| Ink 2 | Fixer A1 | 1.01 | 1.05 | 0.99 | 1.02 |
| Ink B (comp.) | Fixer B1 | 0.84 | 0.80 | 0.87 | 0.84 |
| Ink 2 | Fixer B1 | 0.93 | 1.01 | 0.95 | 0.96 |
| Ink C (comp.) | No Fixer | 0.98 | 0.88 | 1.03 | 0.96 |
| Ink 3 | No Fixer | 0.99 | 0.91 | 1.01 | 0.97 |
| Ink C (comp.) | Fixer A1 | 1.01 | 0.96 | 1.03 | 1.00 |
| Ink 3 | Fixer A1 | 1.28 | 1.30 | 1.27 | 1.28 |
| Ink C (comp.) | Fixer B1 | 0.98 | 0.95 | 1.01 | 0.98 |
| Ink 3 | Fixer B1 | 1.15 | 1.25 | 1.16 | 1.19 |

Chroma on Various Paper

| Ink | Fixer | HPoff | HCP | X4024 | Average |
|---|---|---|---|---|---|
| Ink A (comp.) | No Fixer | 47.0 | 44.7 | 48.0 | 46.6 |
| Ink 1 | No Fixer | 48.8 | 46.0 | 50.6 | 48.5 |
| Ink A (comp.) | Fixer A1 | 48.7 | 46.0 | 52.3 | 49.0 |
| Ink 1 | Fixer A1 | 51.4 | 50.0 | 58.0 | 53.1 |
| Ink A (comp.) | Fixer B1 | 46.8 | 45.9 | 48.1 | 46.9 |
| Ink 1 | Fixer B1 | 50.4 | 49.6 | 57.9 | 52.6 |
| Ink B (comp.) | No Fixer | 53.3 | 49.5 | 55.6 | 52.8 |
| Ink 2 | No Fixer | 54.4 | 51.1 | 55.3 | 53.6 |
| Ink B (comp.) | Fixer A1 | 56.5 | 54.7 | 57.2 | 56.1 |
| Ink 2 | Fixer A1 | 60.9 | 62.2 | 60.3 | 61.1 |
| Ink B (comp.) | Fixer B1 | 52.8 | 49.2 | 54.5 | 52.2 |
| Ink 2 | Fixer B1 | 56.9 | 58.5 | 57.7 | 57.7 |
| Ink C (comp.) | No Fixer | 79.9 | 74.0 | 82.5 | 78.8 |
| Ink 3 | No Fixer | 81.2 | 75.0 | 81.8 | 79.3 |
| Ink C (comp.) | Fixer A1 | 82.0 | 77.8 | 82.5 | 80.8 |
| Ink 3 | Fixer A1 | 94.9 | 95.0 | 93.5 | 94.5 |
| Ink C (comp.) | Fixer B1 | 80.5 | 76.9 | 81.0 | 79.5 |
| Ink 3 | Fixer B1 | 88.2 | 91.6 | 88.3 | 89.4 |

### Example 2

This example shows that the carboxylated binder can be structured or random, and that a combination of random and structured binders is particularly effective in increasing the optical density when the ink is underprinted with a fixer. It also shows that the inks with binder have improved gloss and, again, that a mixture of structured and unstructured binders gives the highest gloss. The examples are for magenta inks.

The following inks were prepared from the magenta Cabojet® sulfonated self-dispersed pigment dispersions using different concentrations of structured and random soluble carboxylated binders. The inks were printed onto plain paper alone and on top of a previously printed fixer fluid.

This example shows that the soluble carboxylated binder can be structured or random, and that the effective concentration can range from about 0.35% to about 3.0%. A combination of structured and random binders, exemplified in Ink L, was particularly effective at increasing optical density and chroma.

| | Ink 4 | Ink 5 | Ink 6 | Ink 7 | Ink 8 | Ink 9 |
|---|---|---|---|---|---|---|
| Ingredients | | | | | | |
| Dispersion 2 (as % pigment) | 3.0 | 3.0 | 3.0 | 3.0 | 3.0 | 3.0 |
| Binder 1 (as % polymer) | — | — | — | 0.3 | 3.0 | 0.75 |
| Binder 2 (as % polymer) | 0.3 | 0.75 | 3.0 | — | — | 0.75 |
| 1,2-Hexanediol | 4.0 | 4.0 | 4.0 | 4.0 | 4.0 | 4.0 |
| Glycerol | 10.0 | 10.0 | 10.0 | 10.0 | 10.0 | 10.0 |
| Ethylene glycol | 5.0 | 5.0 | 5.0 | 5.0 | 5.0 | 5.0 |
| 2-Pyrrolidone | 3.0 | 3.0 | 3.0 | 3.0 | 3.0 | 3.0 |
| Surfynol ® 465 | 0.2 | 0.2 | 0.2 | 0.2 | 0.2 | 0.2 |
| Water (balance to 100%) | Bal. | Bal. | Bal. | Bal. | Bal. | Bal. |
| Properties | | | | | | |
| Conductivity (ms/cm) | 0.38 | 0.49 | 1.18 | 0.58 | 1.28 | 0.87 |
| pH | 7.74 | 8.23 | 8.36 | 7.94 | 8.59 | 8.13 |
| Viscosity (cps, 25° C.) | 2.3 | 2.4 | 3.0 | 2.6 | 3.2 | 2.7 |

| Print Test | Ink 4 | Ink 5 | Ink 6 | Ink 7 | Ink 8 | Ink 9 |
|---|---|---|---|---|---|---|
| | Optical Density | | | | | |
| No Fixer | 0.88 | 0.86 | 0.80 | 0.85 | 0.80 | 0.86 |
| Over Fixer A1 | 1.03 | 1.00 | 1.00 | 1.01 | 1.03 | 1.09 |
| Over Fixer B1 | 1.05 | 1.04 | 1.02 | 1.03 | 0.96 | 1.09 |
| | Chroma | | | | | |
| No Fixer | 58.6 | 58.0 | 54.6 | 56.9 | 53.8 | 55.0 |
| Over Fixer A1 | 65.3 | 63.9 | 63.1 | 64.4 | 64.5 | 64.1 |
| Over Fixer B1 | 65.2 | 64.7 | 62.7 | 62.8 | 58.7 | 63.4 |

### Example 3

In this example the cyan ink was used in place of the magenta ink of the previous example. Again, it was demonstrated that the presence of carboxylated polymer was advantageous for increasing the optical density and chroma of the ink when underprinted with a fixer. A random and structured polymer in combination was particularly effective.

The following inks were prepared from the cyan Cabojet® sulfonated self-dispersed pigment dispersions using different concentrations of structured and random soluble carboxylated binders. The inks were printed onto plain paper alone, with no fixer, and on top of a previously printed fixer fluid.

| | Ink D (comp.) | Ink 10 | Ink 11 | Ink 12 | Ink 13 | Ink 14 | Ink 15 | Ink 16 |
|---|---|---|---|---|---|---|---|---|
| Ingredients | | | | | | | | |
| Dispersion 1 (as | 3.0 | 3.0 | 3.0 | 3.0 | 3.0 | 3.0 | 3.0 | 3.0 |
| % pigment) | | | | | | | | |
| Binder 1 (as % | — | — | — | — | 0.3 | 0.75 | 3.0 | 1.5 |
| polymer) | | | | | | | | |
| Binder 2 (as % | 0.0 | 0.3 | 0.75 | 3.0 | — | — | — | 0.75 |
| polymer) | | | | | | | | |
| 1,2-Hexanediol | 4.0 | 4.0 | 4.0 | 4.0 | 4.0 | 4.0 | 4.0 | 4.0 |
| Glycerol | 10.0 | 10.0 | 10.0 | 10.0 | 10.0 | 10.0 | 10.0 | 10.0 |
| Ethylene glycol | 5.0 | 5.0 | 5.0 | 5.0 | 5.0 | 5.0 | 5.0 | 5.0 |
| 2-Pyrrolidone | 3.0 | 3.0 | 3.0 | 3.0 | 3.0 | 3.0 | 3.0 | 3.0 |
| Surfynol ® 465 | 0.2 | 0.2 | 0.2 | 0.2 | 0.2 | 0.2 | 0.2 | 0.2 |
| Water (balance to | Bal. | Bal. | Bal. | Bal. | Bal. | Bal. | Bal. | Bal. |
| 100%) | | | | | | | | |
| Properties | | | | | | | | |
| Conductivity | 0.34 | 0.46 | 0.63 | 1.32 | 0.52 | 0.75 | 1.57 | 1.27 |
| (ms/cm) | | | | | | | | |
| pH | 6.26 | 7.88 | 8.21 | 8.53 | 7.72 | 7.93 | 8.2 | 8.2 |
| Viscosity (cps, | 2.0 | 2.1 | 2.2 | 2.8 | 2.2 | 2.4 | 3.4 | 2.8 |
| 25° C.) | | | | | | | | |

| Print Test | Ink D (comp.) | Ink 10 | Ink 11 | Ink 12 | Ink 13 | Ink 14 | Ink 15 | Ink 16 |
|---|---|---|---|---|---|---|---|---|
| | Optical density on Xerox 4024 Paper | | | | | | | |
| No Fixer | 48 | 50 | 50 | 50 | 49 | 48 | 48 | 48 |
| Over Fixer A1 | 53 | 55 | 56 | 58 | 54 | 55 | 55 | 57 |
| Over Fixer B1 | 50 | 57 | 57 | 59 | 56 | 56 | 53 | 56 |
| | Chroma on Xerox 4024 Paper | | | | | | | |
| No Fixer | 0.90 | 0.95 | 0.96 | 0.96 | 0.92 | 0.92 | 0.93 | 0.92 |
| Over Fixer A1 | 0.99 | 1.05 | 1.06 | 1.17 | 0.99 | 1.03 | 1.10 | 1.15 |
| Over Fixer B1 | 0.95 | 1.11 | 1.13 | 1.23 | 1.06 | 1.09 | 1.07 | 1.12 |

### Example 4 (Comparative)

To illustrate the difference in behavior of carboxylated SDP and sulfonated SDP, Ink F (with magenta dispersion 4 carboxylated SDP) was printed with fixer. Results demonstrate, in contrast to sulfonated SDP, that fixer increased the optical density and chroma of carboxylated SDP significantly without the need to add a carboxylated binder. Prints in this example were made with a Canon S750 printer.

WO04065501 (the disclosure of which is incorporated by reference herein for all purposes as if fully set forth) also shows examples where carboxylated SDP has lower OD in presence of polymer additive.

| Ingredients | Ink F |
|---|---|
| Dispersion 4 (as % pigment) | 3.0 |
| 1,2-Hexanediol | 4.0 |
| Glycerol | 10.0 |
| Ethylene glycol | 1.0 |
| 2-Pyrrolidone | 3.0 |
| Surfynol ® 465 | 0.5 |
| Triethanolamine | 0.2 |
| Water (balance to 100%) | Bal. |

| Ink | Fixer | HPoff | HCP | X4024 | (Average) |
|---|---|---|---|---|---|
| | | Optical Density on Various Paper | | | |
| Ink F | No Fixer | 1.06 | 1.02 | 1.07 | 1.05 |
| Ink F | Fixer B1 | 1.23 | 1.16 | 1.27 | 1.22 |
| | | Chroma | | | |
| Ink F | No Fixer | 54.9 | 52.9 | 55.0 | 54.3 |
| Ink F | Fixer B1 | 59.3 | 61.0 | 60.6 | 60.3 |

### Example 5 (Comparative)

This example demonstrates that when a nonionic polymer (Polyethylene glycol, MW 2,000), without carboxylic acid groups, is used in place of the carboxyl-groups containing polymer, it does not help increase OD and chroma when the ink is printed over the fixers.

| Ingredients | Ink G (comp.) | Ink H (comp.) |
|---|---|---|
| Dispersion 5 (as % pigment) | 3.0% | 3.0% |
| Polyethylene glycol (M.W. 2,000) | — | 1.0 |
| 1,2-hexanediol | 4.0 | 4.0 |
| Glycerol | 10.0 | 10.0 |
| Ethylene glycol | 5.0 | 5.0 |
| 2-Pyrrolidone | 3.0 | 3.0 |
| Surfynol ® 465 | 0.2 | 0.2 |
| Water (balance to 100%) | Bal. | Bal. |

| | | Optical Density on Various Paper | | | |
|---|---|---|---|---|---|
| Ink | Fixer | HPoff | HCP | X4024 | (Average) |
| Ink G (comp.) | No Fixer | 0.77 | 0.75 | 0.75 | 0.76 |
| Ink H (comp.) | No Fixer | 0.76 | 0.72 | 0.76 | 0.75 |
| Ink G (comp.) | Fixer A1 | 0.80 | 0.74 | 0.77 | 0.77 |
| Ink H (comp.) | Fixer A1 | 0.82 | 0.76 | 0.80 | 0.79 |
| Ink G (comp.) | Fixer B1 | 0.73 | 0.73 | 0.71 | 0.72 |
| Ink H (comp.) | Fixer B1 | 0.76 | 0.75 | 0.74 | 0.75 |

| | | Chroma on Various Paper | | | |
|---|---|---|---|---|---|
| Ink | Fixer | HPoff | HCP | X4024 | (Average) |
| Ink G (comp.) | No Fixer | 46.2 | 45.3 | 46.3 | 46 |
| Ink H (comp.) | No Fixer | 46.7 | 44.4 | 47.3 | 46 |
| Ink G (comp.) | Fixer A1 | 48.7 | 45.5 | 47.9 | 47 |
| Ink H (comp.) | Fixer A1 | 49.8 | 46.8 | 49.6 | 49 |
| Ink G (comp.) | Fixer B1 | 45.5 | 44.6 | 45.3 | 45 |
| Ink H (comp.) | Fixer B1 | 46.6 | 45.6 | 46.5 | 46 |

### Example 6

The addition of polymer to ink with sulfonated SDP is also advantageous to gloss and DOI when the inks are printed on photo paper. The magenta inks from Example 2 and the cyan inks from Example 3 were printed on Epson Premium Glossy Photo Paper and Melinex Photo Paper and the gloss and DOI was measured. Results show that inks with polymer increased in gloss and DOI compared to inks without polymer. When printing on photo paper, optical and density were high without fixer as the media itself provides the “fixation”.

| | Epson Premium Glossy | | | | | |
|---|---|---|---|---|---|---|
| | Photo Paper | | | Melinex Photo Paper | | |
| | 20° | 60° | | 20° | 60° | |
| Inks | Gloss | Gloss | DOI | Gloss | Gloss | DOI |
| Ink C (comp.) | 25 | 72 | 10 | 21 | 66 | 20 |
| Ink 4 | 27 | 72 | 20 | 21 | 63 | 10 |
| Ink 5 | 39 | 83 | 35 | 28 | 73 | 20 |
| Ink 6 | 65 | 99 | 50 | 59 | 96 | 40 |
| Ink 7 | 29 | 75 | 30 | 29 | 76 | 20 |
| Ink 8 | 58 | 101 | 40 | 49 | 95 | 10 |
| Ink 9 | 79 | 110 | 60 | 56 | 97 | 55 |
| Ink D (comp.) | 49 | 94 | 30 | | | |
| Ink 10 | 55 | 98 | 40 | | | |
| Ink 11 | 72 | 105 | 60 | | | |
| Ink 12 | 52 | 92 | 45 | | | |
| Ink 13 | 44 | 78 | 50 | | | |
| Ink 14 | 82 | 104 | 65 | | | |
| Ink 15 | 58 | 97 | 35 | | | |
| Ink 16 | 63 | 100 | 40 | | | |

1. An inkjet ink set comprising:
(a) a first ink comprising a first colorant, a first carboxyl-groups containing polymer additive and a first aqueous vehicle; and
(b) a fixer ink for the first ink, the fixer ink comprising a fixing agent and a second aqueous vehicle;
wherein, the first colorant is a self-dispersing pigment with sulfonate dispersibility imparting groups.

2. The ink set of claim 1, wherein the fixing agent is selected from the group consisting of a multivalent metal cation, a water-soluble cationic polymer and mixtures thereof.

3. The ink set of claim 1, wherein the carboxyl-groups containing polymer has a number average molecular weight (Mₙ) of from about 1,000 to about 20,000,

4. The ink set of claim 1, wherein the carboxyl-groups containing polymer is comprised of acrylic acid and/or methacrylic acid monomers.

5. The ink set of claim 1, wherein the first colorant is a self-dispersing black pigment.

6. The ink set of claim 1, wherein the ink set further comprises a second and third ink, said second ink comprising a second colorant, a second carboxyl-groups containing polymer additive and a third aqueous vehicle; and said third ink comprising a third colorant, a third carboxyl-groups containing polymer additive and a fourth aqueous vehicle; wherein the second and third colorants are both self-dispersing pigments with sulfonate dispersibilty imparting groups, and the color of each of the first, second and third inks is different.

7. The ink set of claim 6, wherein the first, second and third inks are, respectively, cyan, magenta and yellow in color.

8. The ink set of claim 6, further comprising a fourth ink comprising a fourth colorant and a fifth aqueous vehicle, wherein the fourth colorant is a self-dispersing carbon black pigment with carboxylate dispersibility imparting groups.

9. The ink set of claim 1, wherein the carboxyl-groups containing polymer additive comprises a combination of both a random carboxyl-groups containing polymer and a structured carboxyl-groups containing polymer.

10. A method for ink jet printing onto a substrate, comprising the steps of:
(a) providing an ink jet printer that is responsive to digital data signals;
(b) loading the printer with a substrate to be printed;
(c) loading the printer with an inkjet ink set; and
(d) printing onto the substrate using the inkjet ink set in response to the digital data signals,
wherein the inkjet ink set comprises:
(a) a first ink comprising a first colorant, a first carboxyl-groups containing polymer additive and a first aqueous vehicle; and
(b) a fixer ink for the first ink, the fixer ink comprising a fixing agent and a second aqueous vehicle,
wherein the first colorant is a self-dispersing pigment with sulfonate dispersibility imparting groups.

11. The method of claim 10, wherein the fixing agent is selected from the group consisting of a multivalent metal cation, a water-soluble cationic polymer and mixtures thereof.

12. The method of claim 10, wherein the carboxyl-groups containing polymer has a number average molecular weight (Mₙ) of from about 1,000 to about 20,000,

13. The method of claim 10, wherein the carboxyl-groups containing polymer is comprised of acrylic acid and/or methacrylic acid monomers.

14. The method of claim 10, wherein the first colorant is a self-dispersing black pigment.

15. The method of claim 10, wherein the ink set further comprises a second and third ink, said second ink comprising a second colorant, a second carboxyl-groups containing polymer additive and a third aqueous vehicle; and said third ink comprising a third colorant, a third carboxyl-groups containing polymer additive and a fourth aqueous vehicle; wherein the second and third colorants are both self-dispersing pigments with sulfonate dispersibilty imparting groups, and the color of each of the first, second and third inks is different.

16. The method of claim 15, wherein the first, second and third inks are, respectively, cyan, magenta and yellow in color.

17. The method of claim 15, further comprising a fourth ink comprising a fourth colorant and a fifth aqueous vehicle, wherein the fourth colorant is a self-dispersing carbon black pigment with carboxylate dispersibility imparting groups.

18. The method of claim 10, wherein the carboxyl-groups containing polymer additive comprises a combination of both a random carboxyl-groups containing polymer and a structured carboxyl-groups containing polymer.

19. The method of claim 10, wherein the substrate is paper.
